(19) United States
(12) Patent Application Publication
(10) Pub. No.: US 2004/0252652 A1
(43) Pub. Date: Dec. 16, 2004

(54) Cross correlation, bulk delay estimation, and echo cancellation

(76) Inventors: Alexander Berestesky, Ashland, MA (US); Keith Byerly, Wellesley Hills, MA (US); James P. Rafferty, Norfolk, MA (US)

Correspondence Address: FISH & RICHARDSON PC, 225 FRANKLIN ST, BOSTON, MA, 02110, US

(21) Appl. No.: 10/458,350

(22) Filed: Jun. 10, 2003

(51) Int. Cl. H04B 3/20

(52) U.S. Cl. 370/286

(57) ABSTRACT

Whitening is performed on at least a far-end communication signal to reduce a number of averages that must be calculated with respect to a cross-correlation process applied to the far-end signal and a near-end signal. The far-end signal is delivered to a near-end user device without having been whitened. The result of the cross-correlation process is used to estimate a bulk delay of one of the near-end and far-end signals relative to the other.

### BACKGROUND

This description relates to cross correlation, bulk delay estimation, and echo cancellation.

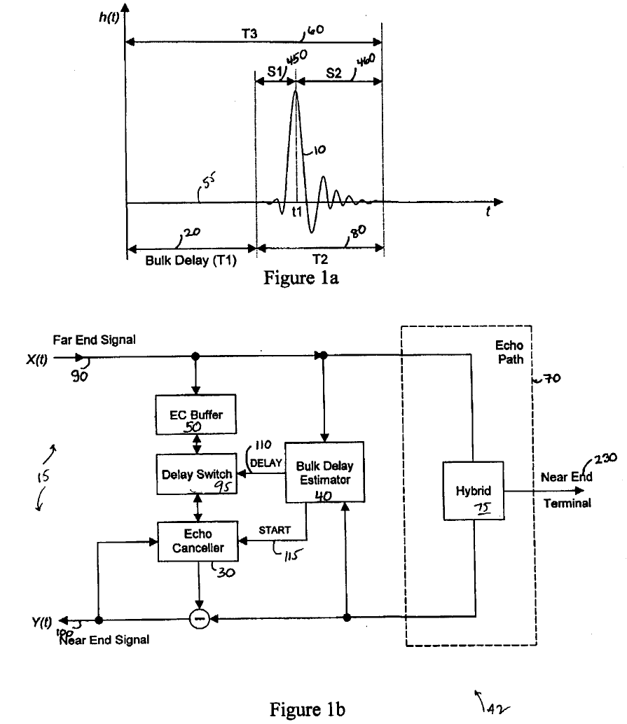

Many telecommunication systems, including voice-over IP and satellite-linked phone channels, have large propagation delays, which makes the presence of echo more noticeable. An echo is produced, for example, when a hybrid circuit reflects part of an incoming signal back to the transmitting terminal. Some systems have bulk propagation delays as large as 128 ms. FIG. 1a illustrates an echo path's impulse response 10 having a bulk delay 20 and a length 80. Cancellation devices correct echo but are computationally intensive for echoes with long impulse responses.

U.S. Pat. No. 4,582,963 discloses a delay detection algorithm based on direct time measurement between incoming and outgoing signals. U.S. Pat. 5,721,782 describes a partitioned echo canceller that uses sampling frequency conversion to resolve adaptation for a long-tail echo canceller. U.S. Pat. No. 5,951,626 proposes an algorithm to handle long impulse response adaptation by assigning adaptation gains to coefficients based on their values.

A well-known method for determining bulk delay is based on normalized correlation estimated between outgoing and incoming signals. The position of the maximum of the correlation function defines the bulk delay. Adaptation of the echo canceller begins after estimating the bulk delay. United Kingdom patent 2,135,558 and U.S. Pat. No. 4,562,312 use sampling frequency conversion to decrease the amount of computation necessary to find the maximum of the correlation function. European patent 0,221,221 attempts to decrease the amount of calculation using a correlation between power estimates of corresponding signals. Deleting the normalization term from the expression for correlation simplifies the correlation estimate, as suggested in U.S. Pat. No. 4,764,955.

To overcome the non-stationary properties of speech signals, European patent 0,199,879 uses a training signal.

U.S. Pat. No. 5,737,410 distributes the computation over a longer interval, which delays the start of adaptation of the echo canceller.

### SUMMARY

In general, in one aspect, the invention features a method that includes whitening at least a far-end communication signal to reduce a number of averages that must be calculated with respect to a cross-correlation process applied to the far-end signal and a near-end signal, the far-end signal being delivered to a near-end user device without having been whitened; and using the result of the cross-correlation process to estimate a bulk delay of one of the near-end and far-end signals relative to the other.

Implementations of the invention may include one or more of the following features. The whitening of at least a far-end communication signal de-emphasizes side lobes in an autocorrelation function of the signal. The whitening includes causing the signal to have more nearly white-noise-like properties. The whitening includes a linear operation. The near-end and far-end signals include an original signal and an echo. The echo is cancelled based on the bulk delay. The whitening is applied also to the near-end signal.

In general, in another aspect, the invention features a method that includes estimating the signs of samples of two communication signals, accumulating samples of one of the signals based on the comparison of the signs to form an estimated cross-correlation of the two signals, performing normalization of the accumulated result, and estimating a bulk delay based on the result of the normalization.

Implementations of the invention may include one or more of the following features. Each of the two communication signals is whitened before the comparison. The samples are added to an accumulated value if the signs match and are subtracted from the accumulated value if the signs do not match. The accumulated value is normalized by the power estimate of the echo signal.

In general, in another aspect, the invention features an apparatus that includes a bulk delay estimator to estimate the bulk delay of a far-end signal relative to a near-end signal, an echo canceller, and a mechanism to delay the operation of the echo canceller based on the bulk delay.

Implementations of the invention may include one or more of the following features. The mechanism includes a delay switch controlled by the amount of the bulk delay. A buffer fetches and buffers samples of the far-end signal and delivers them to the echo canceller.

In general, in another aspect, the invention features an apparatus that includes (a) a port to receive a far-end signal and a near-end signal, (b) circuitry to whiten at least the far-end signal to reduce a number of averages that must be calculated with respect to a cross-correlation process applied to the far-end signal and the near-end signal, the far-end signal being delivered to a near-end user device without having been whitened, (c) cross-correlation elements to determine information about a cross-correlation of the near-end and far-end signals, and (d) an estimator to estimate a bulk delay of one of the near-end and far-end signals relative to the other based on the cross-correlation information.

In general, in another aspect, the invention features a method comprising (a) pre-processing at least one of two communication signals to reduce a number of averages that must be calculated with respect to a cross-correlation process applied to the communication signals, (b) in the cross-correlation process, comparing signs of samples of the two communication signals, accumulating samples of one of the signals based on the comparison of the signs to form an estimated cross-correlation of the two signals, and normalizing the sum by a power estimate of one of the signals, and (c) using the result of the cross-correlation process to estimate a bulk delay of one of the near-end and far-end signals relative to the other.

In general, in another aspect, the invention features an apparatus comprising (a) a bulk delay estimator to estimate the bulk delay of a far-end signal relative to a near-end signal, (b) an echo canceller, (c) a mechanism to delay the operation of the echo canceller based on the bulk delay, the mechanism comprising a port to receive the far-end and near-end signals, whitening circuitry to whiten at least the far-end signal to reduce a number of averages that must be calculated with respect to a cross-correlation process applied to the near-end and far-end signals, and cross-correlation elements to determine information about a cross-correlation of the two signals, and (d) an estimator to estimate a bulk delay of one of the two signals relative to the other based on the cross-correlation information.

In general, in another aspect, the invention features a bulk delay estimation method that includes (a) applying a linear whitening process to at least a far-end signal carried on a communication channel to reduce a number of averages that must be calculated with respect to a cross-correlation process applied to the far-end signal and a near-end signal and improve the resolution of the correlation estimate, (b) using the result of the cross-correlation process to determine a bulk delay of one of the two signals relative to the other, and (c) canceling an echo based on the bulk delay.

In general, in another aspect the invention features a bulk delay estimation method comprising whitening samples of a near-end signal and a far-end echo carried on a communication channel, comparing signs of the samples of each of the two communication signals, adding samples of one of the signals to an accumulated value if the signs match and subtracting the samples if the signs do not match, normalizing the result by the power estimate of the echo signal, and estimating a bulk delay based on the estimated cross-correlation.

Among the advantages of the invention are one or more of the following. Whitening of the speech signal may decrease the number of averages required to detect accurately the position of the correlation function's main maximum. The delay may be estimated more quickly. Whitening also improves resolution of the correlation estimate. Improved resolution permits detection of multiple echo paths, each with its own delay.

Other advantages and features will become apparent from the following description and from the claims.

### DESCRIPTION

FIG. 1a shows an echo signal.

(FIG. 1b is a block diagram of circuitry.

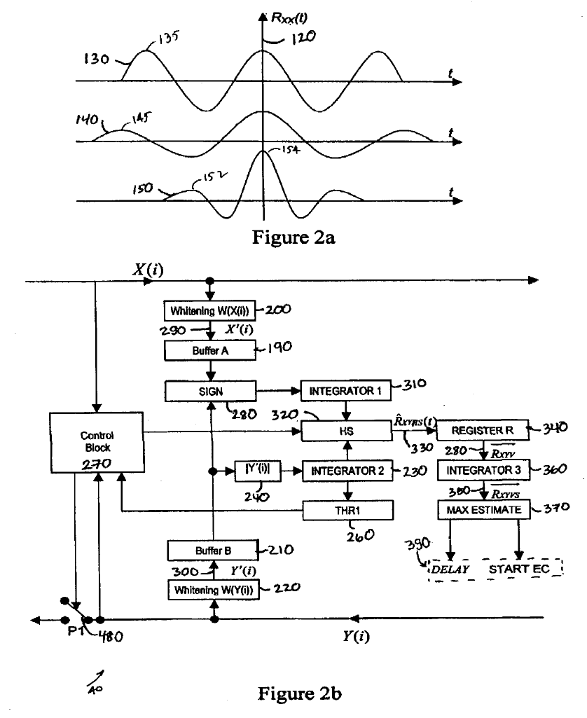

FIG. 2a shows correlation curves.

FIG. 2b shows a block diagram of a bulk delay estimator.

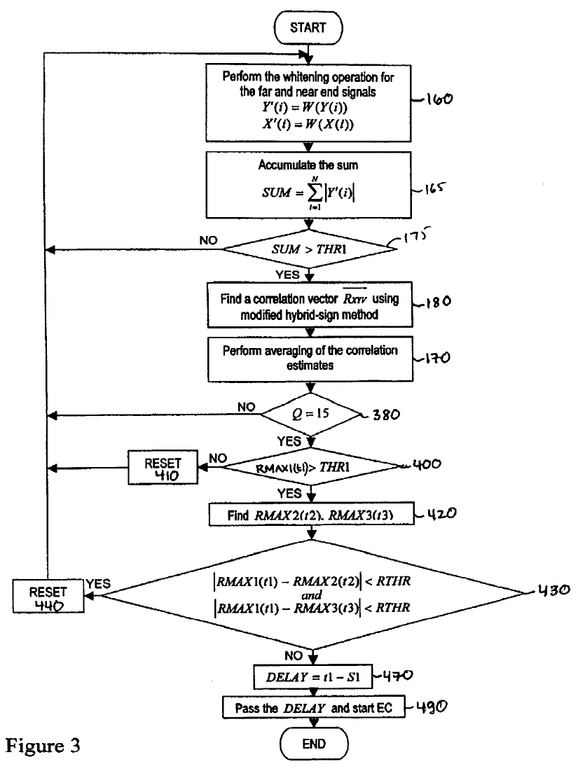

FIG. 3 is a flow chart of bulk delay estimation.)

As shown in FIGS. 1a and 1b, the impulse response 55 of the echo path 70 includes the impulse response 10 of the hybrid balance circuit 75 and the bulk delay T1 20 imparted by the channel. T3 60 represents the duration of impulse response 55 of the echo path 70.

A bulk delay estimator (BDE) 40 generates an estimate 110 of the duration 20 of the bulk delay, passes the estimated duration to a delay switch 95 and starts 115 a typical echo canceller (EC) 30. The delay switch causes the EC to perform adaptation and echo cancellation using samples accumulated by an EC buffer that are delayed by the time interval 20 equal to the bulk delay. Delaying the samples enables the EC to restrict its adaptation process to the non-zero part 10 of the impulse response of the echo path and to use an impulse response 10 that is shorter than the full duration of the echo path (T3 60). In effect, the EC is enabled to cancel an echo over a period longer than the echo canceller's impulse response.

It is known to estimate a bulk delay based on the maximum of a correlation function R_{XY}(t) between far-end 90 and near-end 100 signals, presuming the latter to contain only echo. Most simply, when the echo path produces no dispersion, a delayed version of the far-end signal's autocorrelation function R_{XX}(t) defines correlation function R_{XY}(t), if:

R_{XY}(t)=R_{XX}(t−T) (1)

where T is a delay (e.g., bulk delay T1 ) introduced by the echo path. The shape of R_{XY}(t) thus depends on the shape of R_{XX}(t).

FIG. 2a shows example autocorrelation functions for a tone signal 130, a narrow-band noise signal 140, and a wide-band noise signal 150. If the spectrum of the far-end signal X(t) is similar to wide-band noise 150, the position of the maximum of R_{XY}(t) will define delay T, because the maximum 120 of the shifted autocorrelation function will be easily distinguishable from any of the shorter side lobes 152 of the cross-correlation function. However, if R_{XX}(t) is similar to curves 130 or 140, the side lobes 135, 145 of the delay shifted autocorrelation function may mask the position of the maximum of the cross-correlation function.

A typical telephone channel has a dispersed echo path, which causes R_{XY}(t) to dilate and makes detecting the maximum even more difficult. If X(t) has spectrum properties similar to wide band noise 150 and R_{XX}(t) has a high ratio of main peak to side lobes, calculating the peak of R_{XY}(t) involves fewer averages and is quicker.

Speech is a non-stationary signal with time-changing properties. Vowels, comprising speech's loudest parts, have autocorrelation properties similar to narrow-band signals 140. A whitening operation is applied to the speech signal on the input of the bulk delay estimator, to make the autocorrelation function look more like curve 150 in FIG. 2a and less like curve 145.

As included in the flow-chart of FIG. 3, whitening 160 is a linear operation that converts X(t) into a new signal X′(t) having white noise-like properties. Whitening may be performed by a filter having a frequency response inverse to the spectrum of an incoming signal. The output of the filter for a given input signal will have an even spectrum (equal amplitude at all frequencies), like white noise. The energy of the autocorrelation function of the whitened signal, as for broadband noise, is concentrated primarily in the main lobe.

The lower side lobes of the correlation function of the whitened signal reduces the number of required averaging computations, reduces the time required to determine the maximum, and improves the resolution of the estimate of the correlation maximum. Improvement is significant for multiple echo paths with channels having several reflection points and an autocorrelation function with several maximums. The improved resolution aids the detection of the delays associated with weak echo signals in the presence of strong echo signal

As the speech spectrum changes, the whitening filter's frequency response should also change. Or the frequency response of the filter may be matched with a long-term averaged, speech-based spectrum, which allows use of a fixed filter and decreases the computational load. In the example described below, we use the fixed filter approach.

Computational requirements are important to the selection of a method to estimate bulk delay.

The following expression defines a direct method for calculating the normalized cross-correlation:

$$\overline{{R}_{XY}} ( t ) = \frac{\overline{{C}_{XY}} ( t )}{{D}_{X} \cdot {D}_{Y}} , \vert \overline{{R}_{XY}} ( t ) \vert \leq t where \\ \overline{{C}_{XY}} ( t ) = 1 / N {\sum }_{i = 1}^{N} ( Y ( i ) - \overline{Y} ) ( X ( i - t ) - \overline{X} ) , \\ X = 1 / N {\sum }_{i = 1}^{N} X ( i ) , \\ {D}_{X} = {( 1 / N {\sum }_{i = 1}^{N} {( X ( i ) - \overline{X} )}^{2} )}^{1 / 2} \qquad ( 2 )$$

N=the fetch length, and \overline{Y} and D_{Y} are similarly defined for the near-end signal. The square root in the expression can be calculated using the power series:

\sqrt{1−x}=1−0.5x−0.125x^{2- . . .}

In BDE 40, the direct method (2) for calculating the cross-correlation is replaced by a hybrid sign (HS) estimate 180 of the cross-correlation:

$${R}_{XYHS} ( t ) = \frac{{\sum }_{i = 1}^{N} [ ( Y ( i ) - \overline{Y} ) \cdot sign ( X ( i - t ) - \overline{X} ) ]}{{\sum }_{i = 1}^{N} \vert ( Y ( i ) - \overline{Y} \vert} \qquad ( 3 )$$

If the frequency response of the whitening results in \overline{X}=\overline{Y}=0, the hybrid sign estimate further decreases the required computation:

$${\hat{R}}_{XYHS} ( t ) = \frac{{\sum }_{i = 1}^{N} [ Y ( i ) - \overline{Y} \cdot sign X ( i - t ) ]}{{\sum }_{i = 1}^{N} \vert ( Y ( i ) \vert} \qquad ( 4 )$$

Simulation and implementation have confirmed that (4) provides an acceptable accuracy for an estimate. Compared to the direct method, the HS method decreases the required processing rate by a factor of three.

In some implementations, the BDE may be structured and operated as shown in FIGS. 2b and 3.

Both the far-end signal and the near-end signal are subjected to whitening 160 in whitening processors 200, 220. The whitening of the far-end and near-end signals is performed at the input of the BDE. The far-end signal that passes to the end user device has not been distorted by whitening. The whitened samples are buffered respectively in buffers A and B 190, 210. M=K+N defines the fetch length stored in Buffer A, where K is the maximum delay that the system must be capable of detecting, and N is the fetch length of buffer B 210. In this example, the accumulated fetch length of buffer B is N=64 samples.

As each of the whitened samples is fetched into buffer B, an element 240 takes its absolute value, and an integrator 2 230 integrates (SUMs 165) the absolute values of Y′(i) .

When all 64 samples of the fetch length have been stored in buffer B, a threshold device 260 compares 175 the output of the integrator 2 to a threshold value THR1. If the value THR1 is exceeded, indicating the presence of an echo, a signal is sent to a control block 270. Otherwise, another 64 signal samples are fetched into the buffer B for processing as explained above.

When the control block receives the signal from the threshold device 260, the control block initiates calculation 180 of the cross-correlation for all possible values of the delay −t(K>t>0) beginning with the largest delay, K.

The HS approach of equation 4 is used to determine the cross-correlation for each delay. For each sample, a sign block 280 compares the sign of each of the whitened near-end signal samples X′(i) 290 to the sign of the corresponding whitened far-end signal sample Y′(i) 300. If sign X′(i)=sign Y′(i), then Y′(i) is added to the sum being accumulated in an integrator 1 310. Otherwise, Y′(i) is subtracted from the sum being accumulated.

After all N samples have been integrated in integrator 1, an HS block 320 performs normalization 170. Using all possible values of delay, t, the HS block computes \hat{R_{XYHS}}(t) 330, which is the result of the hybrid sign cross-correlation for delay t. A register R 340 stores the \hat{R_{XYVS}}(t) for the t's as a vector \vec{R_{XYV}}280. \vec{R_{XYV}} is added to a vector \vec{R_{XYVS}} 350 in an integrator 360, which produces 350 an average of the correlation estimates for all fetches.

After the required number of averages has been performed, the \vec{R_{XYVS}} vector 350 is sent to a max estimate block 370. In some implementations, the number of averages is Q=15 380. The time required for averaging may vary between 500 ms and 1000 ms depending on the speech properties.

Once the average of the cross-correlations has been found, the position of the maximum value of the cross-correlation is determined. An element of the vector \vec{R_{XYVS}} having a maximum absolute value is found, call it RMAX1(t1), where t1 is the delay corresponding to the maximum element.

If the condition RMAX1>THR1 400 is false, which may indicate that the estimate has been corrupted by noise and near-end signal, all blocks except buffer A 190 are reset and the process is restarted for the next 64 samples.

If the threshold is exceeded, then the second RMAX2(t2) (for a delay t2) and the third maximum RMAX3(t3) (for a delay t3) are determined 420 such that their positions meet the following restrictions:

|t3−t1|>Δ, |t3−t2|>Δ, |t1−t2|>Δ

where t1, t2, and t3 are delays that correspond to the positions of local maximums of the correlation function, and Δ is a fixed threshold. If the conditions:

|RMAX1(t1)−RMAX2(t2)|<RTHR

and

|RMAX1(t1)−RMAX3(t3)|<RTHR

are satisfied 430, indicating the presence of multiple maximums suggesting that the far-end signal is of the narrow-band type, the process resets 440 all blocks except buffer A 190 and restarts with the accumulation of a new fetch.

The delay t1 20 corresponding to the position of RMAX1 defines the location of the impulse response's peak 450 in FIG. 1a. The location of the other non-zero coefficients is defined by:

$$h κ ( i ) = \{ \begin{matrix}a κ ( i ) \neq 0 & t 1 - S 1 < i < t 1 + S2 \\ 0 & otherwise\end{matrix}$$

where S1=0.25·TE and S2=0.75·TE, and TE is the length of the EC impulse response. The delay value 470 passed to the EC 30 is:

DELAY=t1−S1

When the delay value is passed, the BDE is stopped 490.

For the duration of BDE 40 operation, control block 270 continually detects the presence of near-end speech. When near-end speech appears, the BDE stops. When near-end speech is absent, disconnecting the switch P1 480 prevents the echo signal from returning to the far-end terminal.

As soon as the DELAY value is sent to the EC, adaptation starts.

The technique may be applied to canceling echoes in voice signal-carrying networks, including “traditional” telephony TDM networks, packet voice-based networks, and wireless networks, or in combinations of these networks, such as in a call from a wireless handset to an application server or media gateway in a TDM or packet network.

The techniques may be implemented in a wide range of hardware, software, firmware, and combinations of them. A wide variety of approaches can be applied in organizing different hardware, software, and firmware elements, to achieve the functions described above. Some or all of the elements may be integrated with or amount to re-uses of existing devices and circuits already in use for signal processing.

Other implementations and applications are also within the scope of the following claims.

1. A method comprising
whitening at least a far-end communication signal to reduce a number of averages that must be calculated with respect to a cross-correlation process applied to the far-end signal and a near-end signal, the far-end signal being delivered to a near-end user device without having been whitened, and
using the result of the cross-correlation process to estimate a bulk delay of one of the near-end and far-end signals relative to the other.

2. The method of claim 1 in which
the whitening of at least a far-end communication signal de-emphasizes side lobes in an autocorrelation function of the signal at an input of a bulk delay estimator.

3. The method of claim 1 in which the whitening comprises causing the signal to have more nearly white-noise-like properties.

4. The method of claim 1 in which the whitening comprises a linear operation.

5. The method of claim 1 in which the near-end and far-end signals comprise an original signal and an echo.

6. The method of claim 1 also including canceling an echo based on the bulk delay.

7. The method of claim 1 in which the whitening is applied also to the near-end signal.

8. A method comprising
estimating the signs of samples of two communication signals,
accumulating samples of one of the signals based on the comparison of the signs to form an estimated cross-correlation of the two signals,
performing normalization of the accumulated result, and
estimating a bulk delay based on the result of the normalization.

9. The method of claim 8 also including whitening each of the two communication signals before the comparison.

10. The method of claim 8 in which the samples are added to an accumulated value if the signs match and are subtracted from the accumulated value if the signs do not match.

11. The method of claim 10 also including normalizing the accumulated value by the power estimate of the echo signal.

12. Apparatus comprising
a bulk delay estimator to estimate the bulk delay of a far-end signal relative to a near-end signal,
an echo canceller, and
a mechanism to delay the operation of the echo canceller based on the bulk delay.

13. The apparatus of claim 12 in which the mechanism comprises a delay switch controlled by the amount of the bulk delay.

14. The apparatus of claim 12 also including a buffer to fetch and buffer samples of the far-end signal and deliver them to the echo canceller.

15. Apparatus comprising
a port to receive a far-end signal and a near-end signal,
circuitry to whiten at least the far-end signal to reduce a number of averages that must be calculated with respect to a cross-correlation process applied to the far-end signal and the near-end signal, the far-end signal being delivered to a near-end user device without having been whitened,
cross-correlation elements to determine information about a cross-correlation of the near-end and far-end signals, and
an estimator to estimate a bulk delay of one of the near-end and far-end signals relative to the other based on the cross-correlation information.

16. A method comprising
pre-processing at least one of two communication signals to reduce a number of averages that must be calculated with respect to a cross-correlation process applied to the communication signals,
in the cross-correlation process:
comparing signs of samples of the two communication signals,
accumulating samples of one of the signals based on the comparison of the signs to form an estimated cross-correlation of the two signals, and
normalizing the sum by a power estimate of one of the signals, and
using the result of the cross-correlation process to estimate a bulk delay of one of the near-end and far-end signals relative to the other.

17. Apparatus comprising
a bulk delay estimator to estimate the bulk delay of a far-end signal relative to a near-end signal,
an echo canceller,
a mechanism to delay the operation of the echo canceller based on the bulk delay, the mechanism comprising
a port to receive the far-end and near-end signals,
whitening circuitry to whiten at least the far-end signal to reduce a number of averages that must be calculated with respect to a cross-correlation process applied to the near-end and far-end signals, and
cross-correlation elements to determine information about a cross-correlation of the two signals, and
an estimator to estimate a bulk delay of one of the two signals relative to the other based on the cross-correlation information.

18. A bulk delay estimation method comprising
applying a linear whitening process to at least a far-end signal carried on a communication channel to reduce a number of averages that must be calculated with respect to a cross-correlation process applied to the far-end signal and a near-end signal and improve the resolution of the correlation estimate,
using the result of the cross-correlation process to determine a bulk delay of one of the two signals relative to the other, and
canceling an echo based on the bulk delay.

19. A bulk delay estimation method comprising
whitening samples of a near-end signal and a far-end echo carried on a communication channel,
comparing signs of the samples of each of the two communication signals,
adding samples of one of the signals to an accumulated value if the signs match and subtracting the samples if the signs do not match, and normalizing the result by the power estimate of the echo signal, and
estimating a bulk delay based on the estimated cross-correlation.
